(19) United States
(12) Patent Application Publication
(10) Pub. No.: US 2026/0218664 A1
(43) Pub. Date: Jul. 30, 2026

(54) GAS TURBINE CONTROL DEVICE

(71) Applicant: MITSUBISHI HEAVY INDUSTRIES, LTD., Tokyo (JP)

(72) Inventors: Sosuke NAKAMURA, Tokyo (JP); Tomo KAWAKAMI, Tokyo (JP); Mitsuhiro MORISHITA, Tokyo (JP); Taku EGAWA, Tokyo (JP); Koshiro FUKUMOTO, Tokyo (JP); Teruhiro MATSUMOTO, Tokyo (JP)

(21) Appl. No.: 19/147,390

(22) PCT Filed: Jan. 24, 2024
(86) PCT No.: PCT/JP2024/001927

§ 371 Date: Jul. 11, 2025

(30) Foreign Application Priority Data
Mar. 27, 2023 (JP) 2023-049185

(51) Int. Cl. F02C 9/40

(52) U.S. Cl. CPC F02C 9/40; F05D 2220/75

(57) ABSTRACT

The present application relates to a gas turbine control device for controlling a gas turbine including a combustor capable of co-firing a first fuel with a second fuel having a lower heat quantity per unit volume. This device controls the gas turbine on the basis of a control parameter that is obtained by correcting a reference value corresponding to mono-firing of the first fuel, using a correction value. The correction value is calculated such that as the second fuel co-firing ratio increases, the control parameter becomes smaller or larger than the reference value, and the amount of deviation from the reference value increases.

### TECHNICAL FIELD

The present disclosure relates to a gas turbine control device for controlling a gas turbine including a combustor capable of co-firing a first fuel and a second fuel having a lower calorific value per unit volume than the first fuel.

The present application claims the benefit of priority based on Japanese Patent Application No. 2023-049185 filed to the Japanese Patent Office on Mar. 27, 2023, the content of which is incorporated herein by reference.

### BACKGROUND ART

For example, in a thermal power plant, as means for reducing an emission amount of carbon dioxide (CO2), which is a cause of global warming, improving power generation efficiency and actively using fuels other than fossil fuels, such as hydrogen, are being considered (for example, refer to PTL 1).

### CITATION LIST

### Patent Literature

[PTL 1] Japanese Unexamined Patent Application Publication No. 2021

### SUMMARY OF INVENTION

### Technical Problem

In order to reduce an emission amount of carbon dioxide, it is desirable to increase a co-firing ratio of a second fuel (hydrogen) having a relatively lower calorific value per unit volume than a first fuel such as natural gas. However, since hydrogen has low ignition energy and a high combustion speed, when a co-firing ratio of the hydrogen is increased, a possibility of backflow of a flame, or the like increases.

At least one embodiment of the present disclosure has been made in view of the above-described circumstances, and an object of the present disclosure is to provide a gas turbine control device capable of maintaining a stable operating state even in a case where a co-firing ratio of hydrogen is changed.

### Solution to Problem

In order to solve the above-described problems, a gas turbine control device according to one embodiment of the present disclosure is a gas turbine control device for controlling a gas turbine including a combustor capable of co-firing a first fuel and a second fuel having a lower calorific value per unit volume than the first fuel, the gas turbine control device including:

a reference value calculation unit for calculating a reference value for a control parameter that is a pilot fuel distribution ratio with respect to a pilot fuel injection nozzle among a plurality of fuel injection nozzles included in the combustor, the reference value corresponding to a case where the first fuel is exclusively combusted;

a correction value calculation unit for calculating a correction value for correcting the reference value such that the control parameter becomes smaller than the reference value and a deviation amount from the reference value increases as a co-firing ratio of the second fuel increases; and
a control unit for controlling the gas turbine based on the control parameter obtained by correcting the reference value using the correction value.

In order to solve the above-described problems, a gas turbine control device according to another embodiment of the present disclosure is a gas turbine control device for controlling a gas turbine including a combustor capable of co-firing a first fuel and a second fuel having a lower calorific value per unit volume than the first fuel, the gas turbine control device including:
a reference value calculation unit for calculating a reference value for a control parameter that is a pilot fuel distribution ratio with respect to a pilot fuel injection nozzle among a plurality of fuel injection nozzles included in the combustor, the reference value corresponding to a case where the first fuel is exclusively combusted;
a correction value calculation unit for calculating a correction value for correcting the reference value such that the control parameter becomes larger than the reference value and a deviation amount from the reference value increases as a co-firing ratio of the second fuel increases; and
a control unit for controlling the gas turbine to perform a partial load operation based on the control parameter obtained by correcting the reference value using the correction value.

In order to solve the above-described problems, a gas turbine control device according to another embodiment of the present disclosure is a gas turbine control device for controlling a gas turbine including a combustor capable of co-firing a first fuel and a second fuel having a lower calorific value per unit volume than the first fuel, the gas turbine control device including:
a reference value calculation unit for calculating a reference value for a control parameter that is an opening degree of an inlet guide vane of the gas turbine, the reference value corresponding to a case where the first fuel is exclusively combusted;
a correction value calculation unit for calculating a correction value for correcting the reference value such that the control parameter becomes larger than the reference value and a deviation amount from the reference value increases as a co-firing ratio of the second fuel increases; and
a control unit for controlling the gas turbine based on the control parameter obtained by correcting the reference value using the correction value.

In order to solve the above-described problems, a gas turbine control device according to another embodiment of the present disclosure is a gas turbine control device for controlling a gas turbine including a combustor capable of co-firing a first fuel and a second fuel having a lower calorific value per unit volume than the first fuel, the gas turbine control device including:
a reference value calculation unit for calculating a reference value for a control parameter including at least one of a pilot fuel distribution ratio with respect to a pilot fuel injection nozzle among a plurality of fuel injection nozzles included in the combustor, a top hat fuel distribution ratio with respect to a top hat fuel injection nozzle among the plurality of fuel injection nozzles, a fuel distribution ratio between main nozzle groups among the plurality of fuel injection nozzles, or an opening degree of an inlet guide vane of the gas turbine, the reference value corresponding to a case where the first fuel is exclusively combusted;
a correction value calculation unit for calculating a correction value for correcting the reference value such that the control parameter becomes larger than the reference value and a deviation amount from the reference value increases as a co-firing ratio of the second fuel increases; and
a control unit for controlling the gas turbine based on the control parameter obtained by correcting the reference value using the correction value.

In order to solve the above-described problems, a gas turbine control device according to another embodiment of the present disclosure is a gas turbine control device for controlling a gas turbine including a combustor capable of co-firing a first fuel and a second fuel having a lower calorific value per unit volume than the first fuel, the gas turbine control device including:
a reference value calculation unit for calculating a reference value for a control parameter that is a top hat fuel distribution ratio with respect to a top hat fuel injection nozzle among a plurality of fuel injection nozzles included in the combustor, the reference value corresponding to a case where the first fuel is exclusively combusted;
a correction value calculation unit for calculating a correction value for correcting the reference value such that the control parameter becomes smaller than the reference value and a deviation amount from the reference value increases as a co-firing ratio of the second fuel increases; and
a control unit for controlling the gas turbine based on the control parameter obtained by correcting the reference value using the correction value.

### Advantageous Effects of Invention

According to at least one embodiment of the present disclosure, it is possible to provide a gas turbine control device that can maintain a stable operating state even in a case where a co-firing ratio of hydrogen is changed.

### BRIEF DESCRIPTION OF DRAWINGS

FIG. 1 is a diagram illustrating a schematic configuration of a gas turbine according to one embodiment.

FIG. 2 is a sectional configuration example of a combustor of FIG. 1.

FIG. 3 is a diagram illustrating a disposition layout of a main fuel injection nozzle and a pilot fuel injection nozzle of FIG. 2 from a downstream side.

FIG. 4 is a block diagram illustrating a functional configuration of a gas turbine control device according to one embodiment.

FIG. 5 is a graph illustrating a behavior with respect to a co-firing ratio, together with a flame temperature and an emission amount of nitrogen oxide, in a case where a pilot fuel distribution ratio is selected as a control parameter.

FIG. 6 is a graph illustrating a behavior with respect to a co-firing ratio, together with a combustion speed and a fuel-air ratio, in a case where the pilot fuel distribution ratio or an opening degree of an inlet guide vane of the gas turbine is selected as a control parameter.

FIG. 7 is a graph illustrating a behavior with respect to a co-firing ratio, together with a combustion speed and an amplitude value of combustion oscillation, in a case where the pilot fuel distribution ratio, a top hat fuel distribution ratio, a fuel distribution ratio between main nozzle groups, or an opening degree of an inlet guide vane of the gas turbine is selected as the control parameter.

FIG. 8 is a graph illustrating a behavior of a lower combustible limit, a top hat fuel distribution ratio which is a control parameter, and a fuel-air ratio of the top hat fuel injection nozzle with respect to a co-firing ratio.

### DESCRIPTION OF EMBODIMENTS

Hereinafter, some embodiments of the present invention will be described with reference to the accompanying drawings. Meanwhile, configurations described in the embodiments or illustrated in the drawings are not intended to limit the scope of the invention, and are merely examples for description.

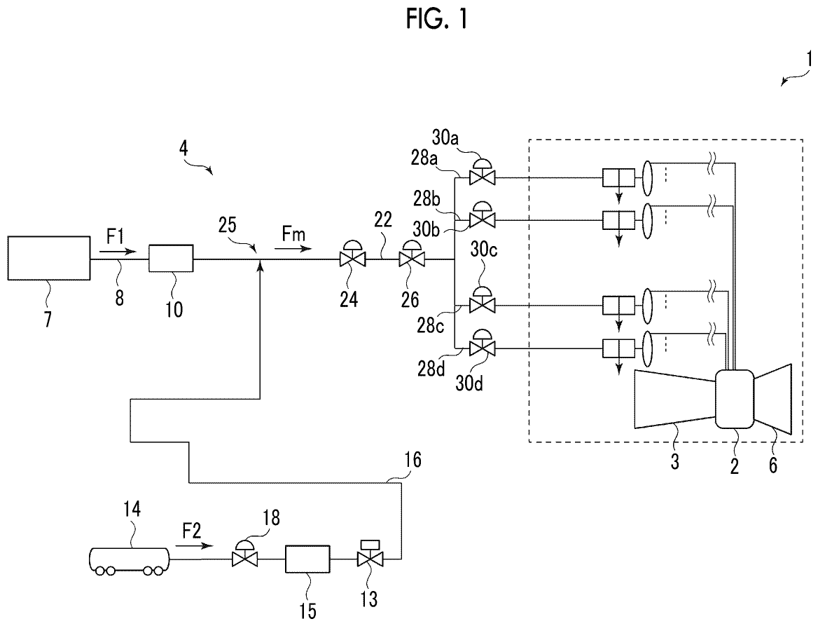

First, a gas turbine which is a control target of a gas turbine control device according to at least one embodiment of the present disclosure will be described with reference to FIG. 1. FIG. 1 is a diagram illustrating a schematic configuration of a gas turbine 1 according to one embodiment.

The gas turbine 1 includes a compressor 3 for generating compressed air, a combustor 2 for generating a combustion gas by co-firing the compressed air generated by the compressor 3 and a fuel, a fuel supply system 4 for supplying the fuel to the combustor 2, and a turbine 6 driven by the combustion gas. The compressor 3 and the turbine 6 are connected to each other on one shaft. In the gas turbine 1 having such a configuration, compressed air compressed by the compressor 3 and fuel supplied from the fuel supply system 4 are supplied to the combustor 2, and the compressed air and the fuel are mixed and combusted to generate combustion gas. The combustion gas flows into the turbine 6 and functions as power for driving the turbine 6.

The fuel supply system 4 handles a mixed fuel in which a first fuel F1 and a second fuel F2 are mixed with each other as the fuel supplied to the combustor 2. The second fuel F2 is a fuel having a lower calorific value per unit volume than the first fuel F1. In the present embodiment, the first fuel F1 is a liquefied natural gas (LNG), and the second fuel F2 is a hydrogen gas.

The first fuel F1 is supplied through a first fuel supply line 8 connected to a first fuel supply source 7. A flowmeter 10 for detecting the flow rate of the first fuel F1 is provided in the first fuel supply line 8.

The second fuel F2 is supplied through a second fuel supply line 16 connected to a second fuel supply source 14. The second fuel supply line 16 is provided with a flowmeter 15 for detecting the flow rate of the second fuel F2, a first flow regulation valve 18 for regulating the flow rate of the second fuel F2, and a shutoff valve 13 for shutting off the second fuel F2.

The first fuel supply line 8 and the second fuel supply line 16 are connected to a main fuel supply line 22 by joining to each other on a downstream side. The first fuel F1 and the second fuel F2 are mixed by being joined at a joining point 25 of the first fuel supply line 8 and the second fuel supply line 16, and the mixed fuel (hereinafter, referred to as “mixed fuel Fm” as appropriate) is sent by the main fuel supply line 22.

In the main fuel supply line 22, a shutoff valve 24 that shuts off the mixed fuel Fm and a second flow regulation valve 26 that adjusts the flow rate of the mixed fuel Fm are provided.

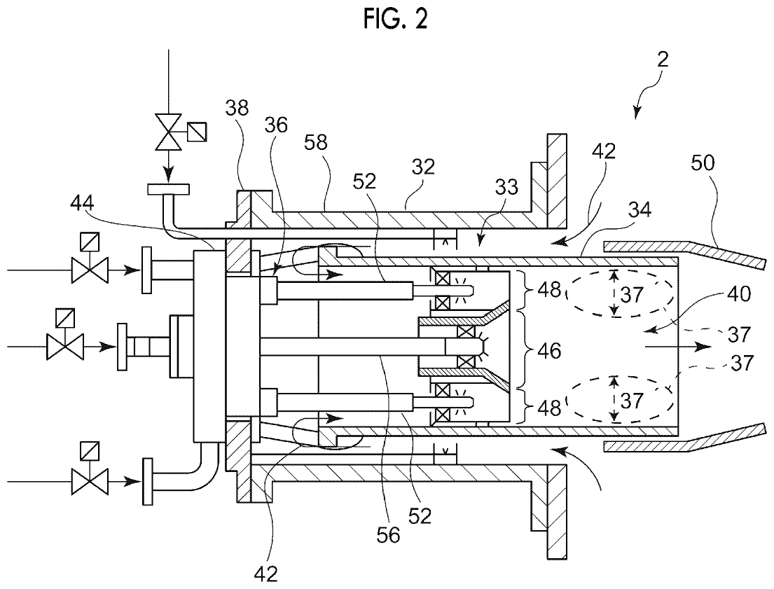

The downstream side of the main fuel supply line 22 branches into a plurality of fuel branch supply lines 28a, 28b, . . . to correspond to a plurality of fuel injection nozzles included in the combustor 2. As will be described later with reference to FIG. 2, the plurality of fuel injection nozzles include a main fuel injection nozzle 52, a pilot fuel injection nozzle 56, and a top hat fuel injection nozzle 58. In addition, at least some of the main fuel injection nozzles 52 may be grouped.

The plurality of fuel branch supply lines 28a, 28b, . . . are respectively provided with third flow regulation valves 30a, 30b, . . . for adjusting the flow rate of the mixed fuel flowing through each line. Among the plurality of fuel branch supply lines 28a, 28b, . . . , the fuel branch supply lines 28a and 28b are connected to the main fuel injection nozzles 52, the fuel branch supply line 28c is connected to the pilot fuel injection nozzle 56, and the fuel branch supply line 28d is connected to the top hat fuel injection nozzle 58.

FIG. 2 is a sectional configuration example of the combustor 2 of FIG. 1. The combustor 2 includes an outer cylinder 32, a liner 34 (inner cylinder), and a burner 36. The outer cylinder 32 is a cylindrical member provided in an outer peripheral portion of a turbine casing (not illustrated). An end portion (head) of the outer cylinder 32 on an upstream side (left side in FIG. 2) is closed by an end cover 38. The liner 34 is a cylindrical combustor inner cylinder that forms a combustion chamber 40 inside, and is installed inside the outer cylinder 32. An annular air flow path 33 is formed between the outer cylinder 32 and the liner 34.

In addition, a large number of air holes are formed in the liner 34. The combustion chamber 40 is a space formed between the burner 36 and a transition piece 50 on the downstream side by the liner 34, and the fuel ejected from the burner 36 is combusted here together with compressed air 42. The transition piece 50 is configured as a member that smoothly connects an inlet (first stage stator vane inlet) of a gas path of the turbine 6 and the liner 34. In addition, the end cover 38 is provided with a fuel distributor 44 that distributes fuel to the burner 36. In addition, although not specifically illustrated, the combustor 2 is also provided with an ignition device that ignites a fuel-air mixture in the combustion chamber 40.

The burner 36 is provided in the end cover 38 so as to be positioned between the combustion chamber 40 and the end cover 38. The burner 36 includes a plurality of element burners, one pilot burner 46 is disposed in a central portion of the combustor 2, and a plurality of main burners 48 are disposed to surround the pilot burner 46 on a radial outer side of the pilot burner 46.

Each main burner 48 includes a plurality of main fuel injection nozzles 52 as fuel injection nozzles.

The pilot burner 46 has a configuration similar to that of the main burner 48 described above, and is located at the center of the plurality of main burners 48. The pilot burner 46 includes the pilot fuel injection nozzle 56 as a fuel injection nozzle.

The air flow path 33 formed between an inner peripheral side of the outer cylinder 32 and an outer peripheral side of the liner 34 is configured to guide the compressed air 42 from the compressor 3 to the inside of the liner 34. The top hat fuel injection nozzle 58 for injecting a top hat fuel is provided in the air flow path 33 as a fuel injection nozzle.

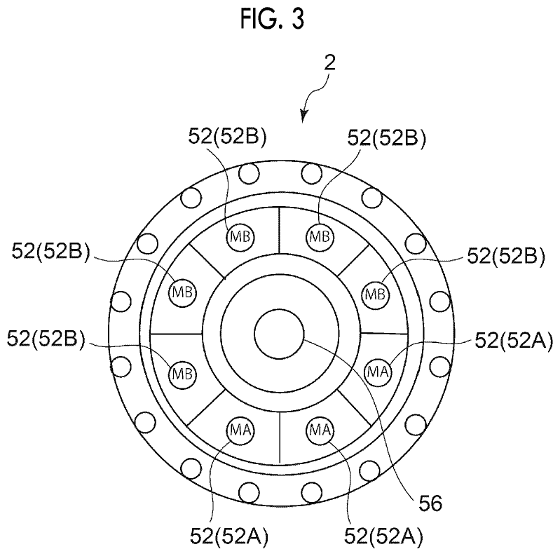

FIG. 3 is a diagram illustrating a disposition layout of the main fuel injection nozzle 52 and the pilot fuel injection nozzle 56 of FIG. 2 from the downstream side. The plurality of main fuel injection nozzles 52 are disposed around the pilot fuel injection nozzle 56 along a circumferential direction. In addition, the plurality of main fuel injection nozzles 52 are classified into a plurality of main fuel injection nozzle groups. In the present embodiment, a total of eight main fuel injection nozzles 52 are provided, and the main fuel injection nozzles 52 are classified into a first main fuel injection nozzle group 52A including five main fuel injection nozzles 52 illustrated below in FIG. 3 and a second main fuel injection nozzle group 52B including three remaining main fuel injection nozzles 52. A fuel distribution ratio KMB between the main nozzle groups to be described later is a value obtained by dividing a second main flow rate MBCSO, which is the flow rate of the fuel supplied to the second main fuel injection nozzle group 52B, by a value obtained by adding a first main flow rate MACSO and a second main flow rate MBCSO, which are flow rates of the fuel supplied to the first main fuel injection nozzle group 52A. Specifically, the fuel distribution ratio KMB between the main nozzle groups is defined by the following equation.

KMB−MBCSO/(MACSO+MBCSO)

Subsequently, a gas turbine control device 100 for controlling the gas turbine 1 having the above-described configuration will be described. The gas turbine control device 100 is a control unit that controls the gas turbine 1, and is configured with, for example, a central processing unit (CPU), a random-access memory (RAM), a read-only memory (ROM), a computer-readable storage medium, or the like. A series of processing for realizing various functions is stored in a storage medium or the like in the form of a program, as an example, and the CPU reads out this program to a RAM or the like, and executes processing for information processing and calculation, whereby various functions are realized. The program may be provided in a form installed in advance in the ROM or other storage medium, a form provided in a state of being stored in a computer-readable storage medium, or a form of being delivered via wired or wireless communication means. The computer-readable storage medium is a magnetic disk, a magneto-optical disk, a CD-ROM, a DVD-ROM, a semiconductor memory, or the like.

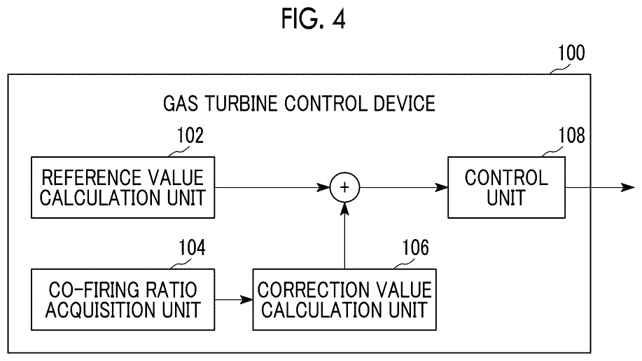

FIG. 4 is a block diagram illustrating a functional configuration of the gas turbine control device 100 according to one embodiment. The gas turbine control device 100 includes a reference value calculation unit 102, a co-firing ratio acquisition unit 104, a correction value calculation unit 106, and a control unit 108.

The reference value calculation unit 102 is configured to calculate a reference value Pref of a control parameter P for controlling the gas turbine 1. The reference value Pref is calculated as the control parameter P during exclusive combustion using the first fuel F1 (in a case where a co-firing ratio R is 0%) based on at least one parameter relating to the operating state of the gas turbine 1.

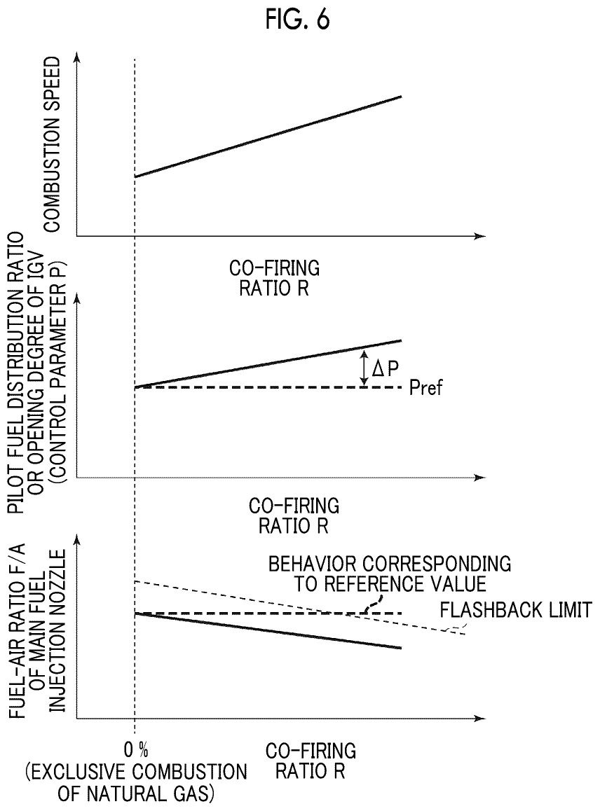

In each embodiment described later with reference to FIGS. 6 to 9, for the sake of simplicity of description, a case where the reference value Pref is constant regardless of a load L of the gas turbine 1 will be described as an example. However, the reference value Pref may be variable according to the load L of the gas turbine 1.

The co-firing ratio acquisition unit 104 is configured to acquire the co-firing ratio R of the second fuel F2. In the present embodiment, the co-firing ratio acquisition unit 104 is configured to acquire the co-firing ratio R calculated based on the flow rate measurement value of the first fuel F1 measured by the flowmeter 10 disposed in the first fuel supply line 8 and the flow rate measurement value of the second fuel F2 measured by the flowmeter 15 disposed in the second fuel supply line 16.

The co-firing ratio acquisition unit 104 may acquire the calculation result of the co-firing ratio R from the outside, or may acquire the co-firing ratio R by acquiring the measurement results of the flowmeters 10 and 15 and the co-firing ratio acquisition unit 104 itself calculating the co-firing ratio R.

The correction value calculation unit 106 is configured to calculate a correction value Pamd for obtaining the control parameter P handled by the gas turbine control device 100 by correcting the reference value Pref. The calculation of the correction value Pamd is performed based on the co-firing ratio R acquired by the co-firing ratio acquisition unit 104. The correlation between the co-firing ratio R and the correction value Pamd is defined for each type of the control parameter P as will be described later with reference to FIGS. 6 to 9.

The combustion speed tends to increase as the co-firing ratio R increases. When the co-firing ratio R increases, the position of a flame 37 (refer to FIG. 2) formed in the combustion chamber 40 shifts to the upstream side. As a result, there is a possibility that an increase in nitrogen oxide (NOx) contained in the exhaust gas from the gas turbine 1, occurrence of flashback, an increase in a risk of combustion oscillation, and the like occurs. In addition, there is a possibility that the occurrence of abnormal combustion (for example, ignition of combustible foreign matter such as seal oil in the combustion chamber 40, and ignition and flame retention of the premixed gas of the top hat) is more likely to occur due to the spread of a combustible range 37′ (range along the width direction of the flame 37) in the combustion chamber 40. These problems can be suitably solved by the correction value calculation unit 106 calculating the correction value Pamd based on the co-firing ratio R for each type of the control parameter P.

The control unit 108 is configured to control the gas turbine 1 by using the control parameter P obtained by correcting the reference value Pref calculated by the reference value calculation unit 102 using the correction value Pamd calculated by the correction value calculation unit 106. In the present embodiment, the control of the gas turbine 1 is performed based on the control parameter P obtained by adding the correction value Pamd to the reference value Pref.

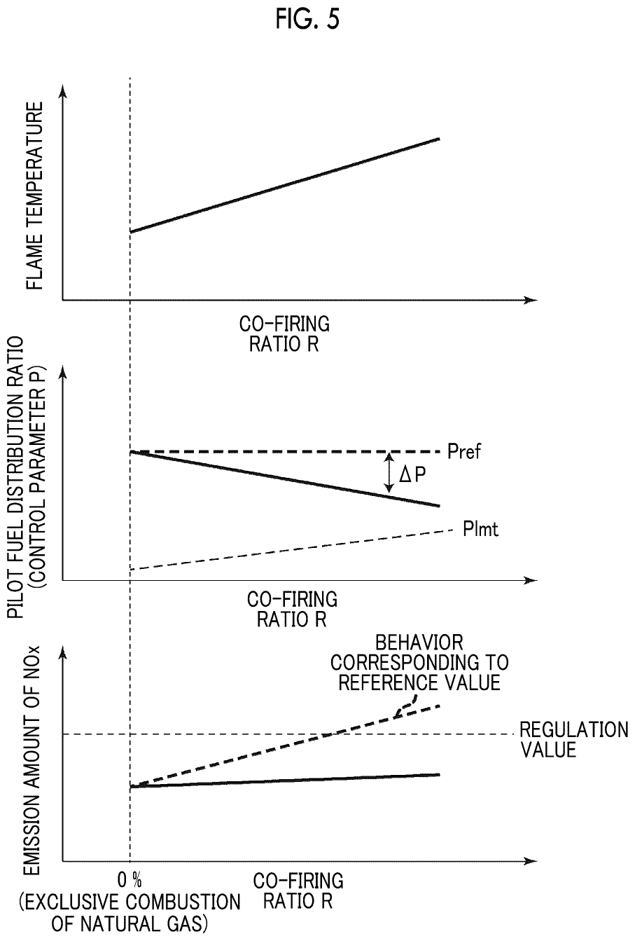

Next, embodiments of the gas turbine control by the gas turbine control device 100 will be specifically described for each type of the control parameter P with reference to FIGS. 5 to 8.

First, a case will be described in which the pilot fuel distribution ratio with respect to the pilot fuel injection nozzle among the plurality of fuel injection nozzles included in the combustor 2 is handled as the control parameter P. FIG. 5 is a graph illustrating the behavior with respect to the co-firing ratio R, together with the flame temperature and the emission amount of nitrogen oxide (NOx), in a case where the pilot fuel distribution ratio is selected as the control parameter P.

The pilot fuel distribution ratio is defined as a ratio of a fuel flow rate supplied to the pilot fuel injection nozzle to a fuel flow rate supplied to all of the plurality of fuel injection nozzles provided in the combustor 2.

The correction value calculation unit 106 calculates the correction value Pamd such that the control parameter P becomes smaller than the reference value Pref and a deviation amount ΔP from the reference value Pref increases as the co-firing ratio R increases. The reference value Pref is calculated based on at least one parameter indicating the operating state of the gas turbine 1 so as to correspond to the exclusive combustion using the first fuel F1. In the present embodiment, the reference value Pref is approximately constant regardless of the co-firing ratio R, and the correction value Pamd is calculated such that the control parameter P decreases as the co-firing ratio R increases.

By controlling the gas turbine 1 based on the control parameter P (pilot fuel distribution ratio) obtained by correcting the reference value Pref using the correction value Pamd in this way, the emission amount of nitrogen oxide (NOx) contained in the exhaust gas can be effectively reduced in the gas turbine 1 subjected to the co-firing operation. When the co-firing ratio R increases, the flame temperature increases due to an increase in the ratio of the second fuel F2 in the mixed fuel. However, by controlling the control parameter (pilot fuel distribution ratio) to be lower than the reference value Pref, the combustion efficiency in a state where the co-firing ratio R is high can be improved, and nitrogen oxide (NOx) can be suppressed. In this manner, the emission amount of nitrogen oxide (NOx) during the co-firing operation can be suppressed to be equal to or less than a regulation value.

In addition, a lower threshold value Plmt may be set for the pilot fuel distribution ratio, which is the control parameter P. The lower threshold value Plmt is set to increase as the co-firing ratio R increases. The larger the co-firing ratio R is, the greater the risk of flashback occurrence is. Therefore, by setting the lower threshold value Plmt to be larger according to the co-firing ratio R in this way, the occurrence of flashback in the gas turbine 1 subjected to the co-firing operation can be effectively avoided.

An embodiment in which the pilot fuel distribution ratio is handled as the control parameter P in this way is suitable, for example, in a case where the gas turbine 1 is operated at full load. In the full load operation, the emission amount of nitrogen oxide (NOx) is relatively large. Therefore, even when the first fuel F1 is exclusively combusted (in a case where the co-firing ratio R is 0%), the emission amount of nitrogen oxide (NOx) approaches a regulation value. In such a case, as the co-firing ratio R increases as described above, the control parameter P (pilot fuel distribution ratio) is controlled to be smaller than the reference value Pref, so that it becomes easier to satisfy the regulation value in a wide range of the co-firing ratio R. Meanwhile, by setting the lower threshold value Plmt for the control parameter P, it is also possible to prevent the occurrence of flashback.

Subsequently, a case will be described in which the pilot fuel distribution ratio with respect to the pilot fuel injection nozzle among the plurality of fuel injection nozzles included in the combustor 2 or an opening degree of an inlet guide vane (IGV) of the gas turbine 1 is handled as the control parameter P. FIG. 6 is a graph illustrating the behavior with respect to the co-firing ratio R, together with the combustion speed and the fuel-air ratio, in a case where the pilot fuel distribution ratio or the opening degree of the inlet guide vane of the gas turbine is selected as the control parameter P.

The correction value calculation unit 106 calculates the correction value Pamd such that the control parameter P becomes larger than the reference value Pref and the deviation amount ΔP from the reference value Pref increases as the co-firing ratio R increases. The reference value Pref is calculated based on at least one parameter indicating the operating state of the gas turbine 1 so as to correspond to the exclusive combustion using the first fuel F1. In the present embodiment, the reference value Pref is approximately constant regardless of the co-firing ratio R, and the correction value Pamd is calculated such that the control parameter P increases as the co-firing ratio R increases.

By controlling the gas turbine 1 based on the control parameter P (pilot fuel distribution ratio) obtained by correcting the reference value Pref using the correction value Pamd in this way, the risk of flashback can be effectively reduced in the gas turbine 1 subjected to the co-firing operation. When the co-firing ratio R increases, the combustion speed increases due to an increase in the ratio of the second fuel F2 in the mixed fuel. However, the combustion speed is suppressed by controlling the control parameter P (pilot fuel distribution ratio or opening degree of the inlet guide vane) to increase with respect to the reference value Pref, and a fuel-air ratio F/A does not exceed a limit value at which flashback may occur. In this manner, the risk of flashback can be effectively suppressed.

In the present embodiment, when the pilot fuel distribution ratio is handled as the control parameter P, it is suitable for a case where the gas turbine 1 is operated under a partial load, for example. In the partial load operation, the emission amount of nitrogen oxide (NOX) is smaller than that in the full load operation described above, and thus there is a margin with respect to the regulation value. In such a case, the pilot fuel distribution ratio may be controlled to increase with respect to the co-firing ratio R, so that the risk of flashback occurrence may be prioritized over the reduction in the emission amount of nitrogen oxide (NOX).

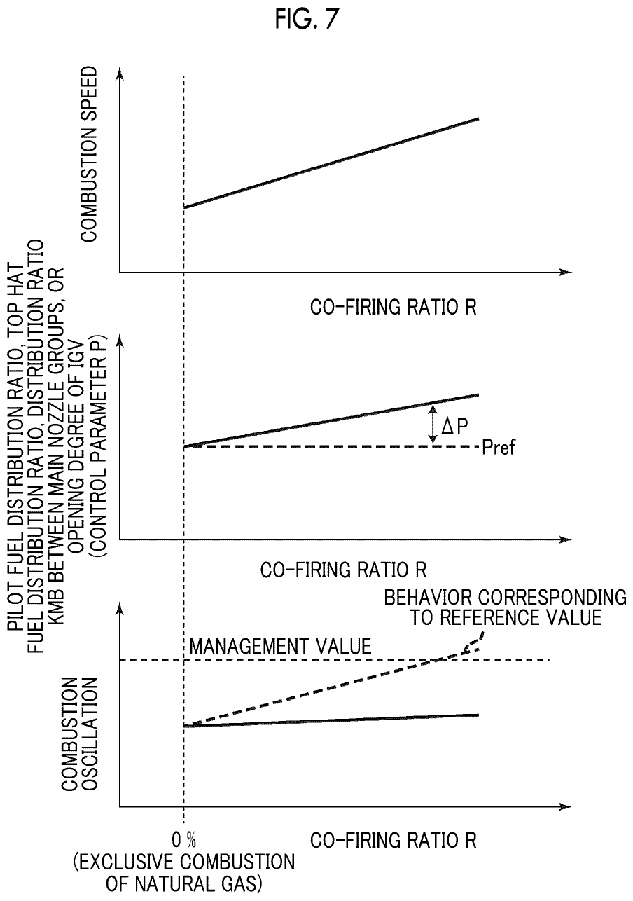

Subsequently, a case will be described in which at least one of the pilot fuel distribution ratio with respect to the pilot fuel injection nozzle among the plurality of fuel injection nozzles included in the combustor 2, the top hat fuel distribution ratio with respect to the top hat fuel injection nozzle among the plurality of fuel injection nozzles, the fuel distribution ratio between the main nozzle groups among the plurality of fuel injection nozzles, or an opening degree of an inlet guide vane of the gas turbine is handled as the control parameter P. FIG. 7 is a graph illustrating the behavior of the co-firing ratio R together with the combustion speed and the amplitude value of the combustion oscillation in a case where the pilot fuel distribution ratio, the top hat fuel distribution ratio, the fuel distribution ratio KMB between the main nozzle groups, or the opening degree of the inlet guide vane of the gas turbine 1 is selected as the control parameter P.

The top hat fuel distribution ratio is defined as a ratio of a fuel flow rate supplied to the top hat fuel injection nozzle to the fuel flow rate supplied to all of the plurality of fuel injection nozzles provided in the combustor 2.

The correction value calculation unit 106 calculates the correction value Pamd such that the control parameter P becomes larger than the reference value Pref and the deviation amount ΔP from the reference value Pref increases as the co-firing ratio R increases. The reference value Pref is calculated based on at least one parameter indicating the operating state of the gas turbine 1 so as to correspond to the exclusive combustion using the first fuel F1. In the present embodiment, the reference value Pref is approximately constant regardless of the co-firing ratio R, and the correction value Pamd is calculated such that the control parameter P increases as the co-firing ratio R increases.

By controlling the gas turbine 1 based on the control parameter P (pilot fuel distribution ratio, top hat fuel distribution ratio, fuel distribution ratio between main nozzle groups, or opening degree of the inlet guide vane) obtained by correcting the reference value Pref using the correction value Pamd in this way, the risk of combustion oscillation can be effectively reduced in the gas turbine 1 subjected to the co-firing operation. When the co-firing ratio R increases, the combustion speed increases because the ratio of the second fuel F2 in the mixed fuel increases. However, by controlling the control parameter P (pilot fuel distribution ratio, top hat fuel distribution ratio, fuel distribution ratio between main nozzle groups, or opening degree of the inlet guide vane) to increase with respect to the reference value Pref, the combustion speed can be suppressed, and the risk of combustion oscillation can be suppressed.

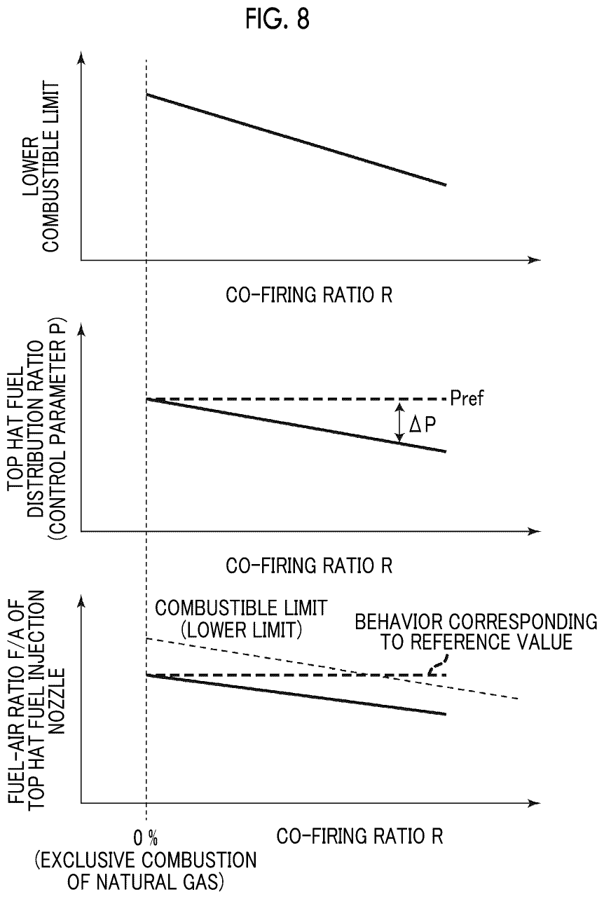

Subsequently, a case will be described in which the top hat fuel distribution ratio for the top hat fuel injection nozzle 58 among the plurality of fuel injection nozzles included in the combustor 2 is handled as the control parameter P. FIG. 8 is a graph illustrating the behavior of the lower combustible limit, the top hat fuel distribution ratio which is the control parameter P, and the co-firing ratio R of the fuel-air ratio F/A in the top hat fuel injection nozzle 58.

The correction value calculation unit 106 calculates the correction value Pamd such that the control parameter P becomes smaller than the reference value Pref and the deviation amount ΔP from the reference value Pref increases as the co-firing ratio R increases. The reference value Pref is calculated based on at least one parameter indicating the operating state of the gas turbine 1 so as to correspond to the exclusive combustion using the first fuel F1. In the present embodiment, the reference value Pref is approximately constant regardless of the co-firing ratio R, and the correction value Pamd is calculated such that the control parameter P decreases as the co-firing ratio R increases.

By controlling the gas turbine 1 based on the control parameter P (top hat fuel distribution ratio) obtained by correcting the reference value Pref using the correction value Pamd in this way, the risk of abnormal combustion can be effectively reduced in the gas turbine 1 subjected to the co-firing operation. When the co-firing ratio R increases, the lower combustible limit decreases due to an increase in the ratio of the second fuel F2 in the mixed fuel. However, by controlling the control parameter P (top hat fuel distribution ratio) to decrease with respect to the reference value Pref, the combustion efficiency in a state where the co-firing ratio R is high can be improved, and the risk of abnormal combustion can be suppressed.

As described above, according to each of the above-described embodiments, it is possible to provide the gas turbine control device 100 that can maintain a stable operating state even in a case where the co-firing ratio R changes.

In addition, it is possible to replace the components in the embodiment described above with well-known components as appropriate within the scope which does not depart from the concept of the present disclosure, and the embodiments described above may be combined with each other as appropriate.

For example, contents disclosed in each of the embodiments are understood as follows.
(1) A gas turbine control device according to one aspect is a gas turbine control device for controlling a gas turbine including a combustor capable of co-firing a first fuel and a second fuel having a lower calorific value per unit volume than the first fuel, the gas turbine control device including:
a reference value calculation unit for calculating a reference value for a control parameter that is a pilot fuel distribution ratio with respect to a pilot fuel injection nozzle among a plurality of fuel injection nozzles included in the combustor, the reference value corresponding to a case where the first fuel is exclusively combusted;
a correction value calculation unit for calculating a correction value for correcting the reference value such that the control parameter becomes smaller than the reference value and a deviation amount from the reference value increases as a co-firing ratio of the second fuel increases; and
a control unit for controlling the gas turbine based on the control parameter obtained by correcting the reference value using the correction value.

According to the aspect of the above (1), the pilot fuel distribution ratio is controlled such that the pilot fuel distribution ratio becomes smaller than the reference value corresponding to the case where the first fuel is exclusively combusted and the deviation amount from the reference value increases as the co-firing ratio of the second fuel increases. In this manner, the gas turbine is controlled such that the pilot fuel distribution ratio decreases as the co-firing ratio increases, so that the flame temperature and the combustion speed are suppressed, and the emission amount of nitrogen oxide (NOx) contained in the exhaust gas can be effectively reduced.

The pilot fuel distribution ratio is defined as a ratio of a fuel flow rate supplied to the pilot fuel injection nozzle to a fuel flow rate supplied to all of the plurality of fuel injection nozzles provided in the combustor.
(2) In another aspect, in the aspect of the above (1), a lower threshold value of the pilot fuel distribution ratio is set to increase as the co-firing ratio increases, and the control unit controls the gas turbine in a range where the pilot fuel distribution ratio is equal to or more than the lower threshold value.

According to the aspect of the above (2), the control of the pilot fuel distribution ratio based on the co-firing ratio is performed in a range equal to or more than the lower threshold value. At this time, the lower threshold value is set to increase as the co-firing ratio increases. In this manner, it is possible to reduce nitrogen oxide (NOx) contained in the exhaust gas while effectively preventing flashback that is likely to occur as the co-firing ratio increases.
(3) In another aspect, in the aspect of the above (1) or (2), the control unit controls the gas turbine to perform a full load operation.

According to the aspect of the above (3), during the full load operation in which the emission amount of the nitrogen oxide (NOx) contained in the exhaust gas is less than the regulation value, the nitrogen oxide (NOX) contained in the exhaust gas can be suitably reduced while the occurrence of flashback is effectively prevented.
(4) A gas turbine control device according to another aspect is a gas turbine control device for controlling a gas turbine including a combustor capable of co-firing a first fuel and a second fuel having a lower calorific value per unit volume than the first fuel, the gas turbine control device including:
a reference value calculation unit for calculating a reference value for a control parameter that is a pilot fuel distribution ratio with respect to a pilot fuel injection nozzle among a plurality of fuel injection nozzles included in the combustor, the reference value corresponding to a case where the first fuel is exclusively combusted;
a correction value calculation unit for calculating a correction value for correcting the reference value such that the control parameter becomes larger than the reference value and a deviation amount from the reference value increases as a co-firing ratio of the second fuel increases; and
a control unit for controlling the gas turbine to perform a partial load operation based on the control parameter obtained by correcting the reference value using the correction value.

According to the aspect of the above (4), when the gas turbine is controlled to perform the partial load operation, the emission amount of the nitrogen oxide (NOx) contained in the exhaust gas has a relatively large margin with respect to the regulation value. In this case, the pilot fuel distribution ratio is controlled such that the pilot fuel distribution ratio becomes larger than the reference value corresponding to the case where the first fuel is exclusively combusted and the deviation amount from the reference value increases as the co-firing ratio of the second fuel increases. In this manner, while the emission amount of nitrogen oxide (NOX) contained in the exhaust gas satisfies the regulation value in a high co-firing ratio range where flashback is likely to occur, the pilot fuel distribution ratio is increased. In this manner, the flame position formed in the combustor is shifted to the downstream side, and the risk of flashback occurrence can be more effectively reduced.
(5) A gas turbine control device according to another aspect is a gas turbine control device for controlling a gas turbine including a combustor capable of co-firing a first fuel and a second fuel having a lower calorific value per unit volume than the first fuel, the gas turbine control device including:
a reference value calculation unit for calculating a reference value for a control parameter that is an opening degree of an inlet guide vane of the gas turbine, the reference value corresponding to a case where the first fuel is exclusively combusted;
a correction value calculation unit for calculating a correction value for correcting the reference value such that the control parameter becomes larger than the reference value and a deviation amount from the reference value increases as a co-firing ratio of the second fuel increases; and
a control unit for controlling the gas turbine based on the control parameter obtained by correcting the reference value using the correction value.

According to the aspect of the above (5), the opening degree of the inlet guide vane is controlled such that the opening degree of the inlet guide vane becomes larger than the reference value corresponding to the case where the first fuel is exclusively combusted and the deviation amount from the reference value increases as the co-firing ratio of the second fuel increases. In this manner, the gas turbine is controlled such that the opening degree of the inlet guide vane increases as the co-firing ratio increases, so that the risk of flashback can be effectively reduced.
(6) A gas turbine control device according to another aspect is a gas turbine control device for controlling a gas turbine including a combustor capable of co-firing a first fuel and a second fuel having a lower calorific value per unit volume than the first fuel, the gas turbine control device including:
a reference value calculation unit for calculating a reference value for a control parameter including at least one of a pilot fuel distribution ratio with respect to a pilot fuel injection nozzle among a plurality of fuel injection nozzles included in the combustor, a top hat fuel distribution ratio with respect to a top hat fuel injection nozzle among the plurality of fuel injection nozzles, a fuel distribution ratio between main nozzle groups among the plurality of fuel injection nozzles, or an opening degree of an inlet guide vane of the gas turbine, the reference value corresponding to a case where the first fuel is exclusively combusted;
a correction value calculation unit for calculating a correction value for correcting the reference value such that the control parameter becomes larger than the reference value and a deviation amount from the reference value increases as a co-firing ratio of the second fuel increases; and a control unit for controlling the gas turbine based on the control parameter obtained by correcting the reference value using the correction value.

According to the aspect of the above (6), as the co-firing ratio of the second fuel increases, at least one of the pilot fuel distribution ratio, the top hat fuel distribution ratio, the fuel distribution ratio between the main nozzle groups, or the opening degree of the inlet guide vane is controlled such that the one becomes larger than the reference value corresponding to the case where the first fuel is exclusively combusted and the deviation amount from the reference value increases as the co-firing ratio of the second fuel increases. In this manner, the gas turbine is controlled such that the control parameters increase as the co-firing ratio increases, and thus the risk of combustion oscillation can be effectively reduced.

The top hat fuel distribution ratio is defined as a ratio of a fuel flow rate supplied to the top hat fuel injection nozzle to the fuel flow rate supplied to all of the plurality of fuel injection nozzles provided in the combustor.
(7) A gas turbine control device according to another aspect is a gas turbine control device for controlling a gas turbine including a combustor capable of co-firing a first fuel and a second fuel having a lower calorific value per unit volume than the first fuel, the gas turbine control device including:
a reference value calculation unit for calculating a reference value for a control parameter that is a top hat fuel distribution ratio with respect to a top hat fuel injection nozzle among a plurality of fuel injection nozzles included in the combustor, the reference value corresponding to a case where the first fuel is exclusively combusted;
a correction value calculation unit for calculating a correction value for correcting the reference value such that the control parameter becomes smaller than the reference value and a deviation amount from the reference value increases as a co-firing ratio of the second fuel increases; and
a control unit for controlling the gas turbine based on the control parameter obtained by correcting the reference value using the correction value.

According to the aspect of the above (7), the top hat fuel distribution ratio is controlled such that the top hat fuel distribution ratio becomes smaller than the reference value corresponding to the case where the first fuel is exclusively combusted and the deviation amount from the reference value increases as the co-firing ratio of the second fuel increases.

In this manner, the gas turbine is controlled such that the top hat fuel distribution ratio increases as the co-firing ratio increases, so that the risk of occurrence of abnormal combustion can be effectively reduced.

### REFERENCE SIGNS LIST

1: Gas turbine
2: Combustor
3: Compressor
6: Turbine
7: First fuel supply source
8: First fuel supply line
10: Flowmeter
13: Shutoff valve
14: Second fuel supply source
15: Flowmeter
16: Second fuel supply line
18: First flow regulation valve
22: Main fuel supply line
24: Shutoff valve
25: Joining point
26: Second flow regulation valve
30a, 30b, . . . : Third flow regulation valve
32: Outer cylinder
33: Air flow path
34: Liner
36: Burner
37: Flame
37′: Combustible range
38: End cover
42: Compressed air
44: Fuel distributor
46: Pilot burner
48: Main burner
50: Transition piece
52: Main fuel injection nozzle
56: Pilot fuel injection nozzle
58: Top hat fuel injection nozzle
100: Gas turbine control device
102: Reference value calculation unit
104: Co-firing ratio acquisition unit
106: Correction value calculation unit
108: Control unit

1. A gas turbine control device for controlling a gas turbine including a combustor capable of co-firing a first fuel and a second fuel having a lower calorific value per unit volume than the first fuel, the gas turbine control device comprising:
a reference value calculation unit for calculating a reference value for a control parameter that is a pilot fuel distribution ratio with respect to a pilot fuel injection nozzle among a plurality of fuel injection nozzles included in the combustor, the reference value corresponding to a case where the first fuel is exclusively combusted;
a correction value calculation unit for calculating a correction value for correcting the reference value such that the control parameter becomes smaller than the reference value and a deviation amount from the reference value increases as a co-firing ratio of the second fuel increases; and
a control unit for controlling the gas turbine based on the control parameter obtained by correcting the reference value using the correction value.

2. The gas turbine control device according to claim 1, wherein a lower threshold value of the pilot fuel distribution ratio is set to increase as the co-firing ratio increases, and
the control unit controls the gas turbine in a range where the pilot fuel distribution ratio is equal to or more than the lower threshold value.

3. The gas turbine control device according to claim 1, wherein the control unit controls the gas turbine to perform a full load operation.

4. A gas turbine control device for controlling a gas turbine including a combustor capable of co-firing a first fuel and a second fuel having a lower calorific value per unit volume than the first fuel, the gas turbine control device comprising:
a reference value calculation unit for calculating a reference value for a control parameter that is a pilot fuel distribution ratio with respect to a pilot fuel injection nozzle among a plurality of fuel injection nozzles included in the combustor, the reference value corresponding to a case where the first fuel is exclusively combusted;
a correction value calculation unit for calculating a correction value for correcting the reference value such that the control parameter becomes larger than the reference value and a deviation amount from the reference value increases as a co-firing ratio of the second fuel increases; and
a control unit for controlling the gas turbine to perform a partial load operation based on the control parameter obtained by correcting the reference value using the correction value.

5. A gas turbine control device for controlling a gas turbine including a combustor capable of co-firing a first fuel and a second fuel having a lower calorific value per unit volume than the first fuel, the gas turbine control device comprising:
a reference value calculation unit for calculating a reference value for a control parameter that is an opening degree of an inlet guide vane of the gas turbine, the reference value corresponding to a case where the first fuel is exclusively combusted;
a correction value calculation unit for calculating a correction value for correcting the reference value such that the control parameter becomes larger than the reference value and a deviation amount from the reference value increases as a co-firing ratio of the second fuel increases; and
a control unit for controlling the gas turbine based on the control parameter obtained by correcting the reference value using the correction value.

6. A gas turbine control device for controlling a gas turbine including a combustor capable of co-firing a first fuel and a second fuel having a lower calorific value per unit volume than the first fuel, the gas turbine control device comprising:
a reference value calculation unit for calculating a reference value for a control parameter including at least one of a pilot fuel distribution ratio with respect to a pilot fuel injection nozzle among a plurality of fuel injection nozzles included in the combustor, a top hat fuel distribution ratio with respect to a top hat fuel injection nozzle among the plurality of fuel injection nozzles, a fuel distribution ratio between main nozzle groups among the plurality of fuel injection nozzles, or an opening degree of an inlet guide vane of the gas turbine, the reference value corresponding to a case where the first fuel is exclusively combusted;
a correction value calculation unit for calculating a correction value for correcting the reference value such that the control parameter becomes larger than the reference value and a deviation amount from the reference value increases as a co-firing ratio of the second fuel increases; and
a control unit for controlling the gas turbine based on the control parameter obtained by correcting the reference value using the correction value.

7. A gas turbine control device for controlling a gas turbine including a combustor capable of co-firing a first fuel and a second fuel having a lower calorific value per unit volume than the first fuel, the gas turbine control device comprising:
a reference value calculation unit for calculating a reference value for a control parameter that is a top hat fuel distribution ratio with respect to a top hat fuel injection nozzle among a plurality of fuel injection nozzles included in the combustor, the reference value corresponding to a case where the first fuel is exclusively combusted;
a correction value calculation unit for calculating a correction value for correcting the reference value such that the control parameter becomes smaller than the reference value and a deviation amount from the reference value increases as a co-firing ratio of the second fuel increases; and
a control unit for controlling the gas turbine based on the control parameter obtained by correcting the reference value using the correction value.
